(19) United States
(12) Patent Application Publication
(10) Pub. No.: US 2007/0295271 A1
(43) Pub. Date: Dec. 27, 2007

(54) High voltage, high pressure coating material conduit

(76) Inventors: Gernot Engel, Dreieich (DE); Ghaffar Kazkaz, Rolling Meadows, IL (US); Joel Albert Richardson, Naperville, IL (US)

Correspondence Address: BARNES & THORNBURG LLP, 11 SOUTH MERIDIAN, INDIANAPOLIS, IN, 46204, US

(21) Appl. No.: 11/451,123

(22) Filed: Jun. 12, 2006

(51) Int. Cl. B05B 5/025

(52) U.S. Cl. 118/629; 118/621

(57) ABSTRACT

A composite coating material delivery conduit includes a first conduit providing a first passageway for coating material to be conveyed through the conduit, a second conduit including a second passageway adapted loosely to receive the first conduit, and an electrically non-insulative layer surrounding the second conduit.

### FIELD OF THE INVENTION

This invention relates to coating material dispensing systems. It is disclosed in the context of a conduit for conducting coating material from a source of coating material to a device from which the coating material is atomized and dispensed.

### BACKGROUND OF THE INVENTION

Conventional hoses for use in high hydraulic pressure electrostatically aided coating dispensing systems are typically multi-layer designs. Such hoses include an inner layer having sufficient burst strength to meet the pressure requirements. This inner layer must also be sufficiently chemically resistant to the coating materials, flushing media, and the like, anticipated to be used in the system. Typical materials for this layer include polytetrafluoroethylene (PTFE), polyvinylidene fluoride (PVDF), polyamides, such as, for example, nylon 6,6, nylon 6, or nylon 11, and polyethylene. A layer of braided synthetic fibers is placed over this inner layer to provide added strength and resist creep due to internal pressures. Typical materials for the layer of braided synthetic fibers include polyamides, such as, for example, nylon 6,6 or nylon 6, aramids, such as, for example, Kevlar or Nomex, and polyester fibers, such as, for example, polyethylene terephthalate (PET) or polyethylene naphthalate (PEN). Finally, an outside layer is used to provide added strength, protection for the layer of braided synthetic fibers, and wear resistance. Typical materials for outside layer include, for example, nylon 11 and polyurethane.

There are also the hoses illustrated and described in, for example, U.S. Pat. No. 5,413,283 and references cited there. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

As used in this application, terms such as “electrically conductive” and “electrically non-insulative” refer to a broad range of conductivities electrically more conductive than materials described as “electrically non-conductive” and “electrically insulative.” Terms such as “electrically semiconductive” refer to a broad range of conductivities between electrically non-insulative and electrically non-conductive.

### DISCLOSURE OF THE INVENTION

According to an aspect of the invention, a coating material delivery conduit includes, in combination, a first conduit providing a first passageway for material to be conveyed through the conduit, an electrically non-conductive second conduit including a second passageway adapted loosely to receive the first conduit, and an electrically non-insulative layer surrounding the second conduit.

Further illustratively according to this aspect of the invention, the combination includes a coating dispensing device, a source of coating material to be dispensed by the coating dispensing device and a power supply including output terminals across which a potential is maintained. The first conduit is coupled between the source and the coating dispensing device. One of the output terminals is coupled to at least one of the coating dispensing device, the source of coating material and the coating material being supplied through the first passageway. The other of the output terminals is coupled to the electrically non-insulative layer surrounding the second conduit.

Illustratively according to this aspect of the invention, the first conduit is adapted to withstand pressure exerted on it by coating material supplied from the source of coating material.

Illustratively according to this aspect of the invention, the first conduit comprises an electrically non-conductive material.

Illustratively according to this aspect of the invention, the second passageway comprises lands and grooves extending longitudinally of the second conduit to aid in insertion of the first conduit into the second conduit.

Illustratively according to this aspect of the invention, the source of coating material comprises a source of electrically non-insulative coating material.

Illustratively according to this aspect of the invention, the second passageway comprises lands and grooves extending longitudinally of the second conduit to aid in insertion of the first conduit into the second conduit.

Illustratively according to this aspect of the invention, the electrically non-insulative layer comprises flexible metal hose around the second conduit.

Alternatively illustratively according to this aspect of the invention, the electrically non-insulative layer comprises a semiconducting braid around the second conduit.

Alternatively illustratively according to this aspect of the invention, the electrically non-insulative layer comprises a non-insulative layer co-extruded with the second conduit

Alternatively illustratively according to this aspect of the invention, the electrically non-insulative layer comprises a semiconductive layer co-extruded with the second conduit

### BRIEF DESCRIPTION OF THE DRAWINGS

The invention may best be understood by referring to the following detailed description and accompanying drawings which illustrate the invention. In the drawings:

FIG. 1 illustrates a prior art hose for use in high hydraulic pressure, electrostatically aided coating dispensing systems;

FIG. 2 illustrates a fragmentary perspective view of a hose constructed according to the invention;

FIG. 3 illustrates an elevational view of a system incorporating a hose constructed according to the invention;

FIGS. 4a-c illustrate cross sectional views of details of three different embodiments of hose constructed according to the invention; and,

FIG. 5 illustrates an elevational view of a test apparatus for validating the performance of hose constructed according to the invention.

### DETAILED DESCRIPTION OF ILLUSTRATIVE EMBODIMENTS

We have developed a hose configuration exhibiting increased durability for high-pressure electrostatic painting systems. Conventional hoses 20 for use in high hydraulic pressure electrostatically aided coating dispensing systems are typically multi-layer designs of the general configuration illustrated in FIG. 1. Such hoses 20 include an inner layer 22 having sufficient burst strength to meet the pressure requirements. This inner layer 22 must also be sufficiently chemically resistant to the coating materials, flushing media, and the like, anticipated to be used in the system. A typical material for this layer 22 is polytetrafluoroethylene (PTFE). A layer 24 of braided synthetic fibers is placed over this inner layer 22 to provide added strength and resist creep due to internal pressures. Typical materials for the layer 24 of braided synthetic fibers include polyamides, such as, for example, nylon 6,6 or nylon 6, aramids, such as, for example, Kevlar or Nomex, and polyester fibers, such as, for example, polyethylene terephthalate (PET) or polyethylene naphthalate (PEN). Finally, an outside layer 26 is used to provide added strength, protection for the layer 24 of braided synthetic fibers, and wear resistance. Typical materials for outside layer 26 include, for example, nylon 11 and polyurethane.

In one application, a hose of the type illustrated in FIG. 1 was to be used with an electrostatically aided, water-based coating material dispensing system 30. The system 30 was designed to accommodate coating material pressures to 193 bar (2,800 lb./in.² or about 146,680 mm Hg or about 19556 kPa). In this electrostatic system 30, the electrostatic power supply 32 was coupled to the dispensing device 34 via the water in the coating material. A voltage of 50 kV was maintained across the output terminals of the electrostatic power supply 32, and thus across the coating material reservoir 36 and ground which are coupled to respective output terminals of the electrostatic power supply 32. In order to provide some margin of error, the hose 20 selected for this application had a pressure rating of 225 bar (3,535 lb./in.² or about 171,000 mm Hg or about 22798 kPa). A ground sleeve 38 was placed over the high-pressure hose 20 and metal fittings 40 swaged to the ends 42, 44 of the hose 20 to permit attachment of the hose 20 to the reservoir 36 and the dispensing device 34. The ground sleeve 38 was constructed from woven metal filled nylon.

Although the hose 20 was rated to 225 bar, it failed in about a day when tested at 100 bar and a power supply 32 voltage of 50 kV. Inspection of the hose 20 revealed that the combination of pressure and voltage resulted in an enhanced diffusion of water through the inner layer 22. This resulted in a breakdown (arcing) of the insulation, and, once the current began to flow, the current caused (a) pinhole(s) to form in inner layer 22, shorting the power supply 32. The failure of this hose 20 was unanticipated. The hose 20 was rated for 250 bar (3,626 psi) with a burst pressure of 1,000 bar (14,504 psi). The hose 20 also should have been able to withstand the test voltages as it should have withstood 55.7 kV. It failed in less than a day when exposed to 50 kV and only 105 bar (1,500 psi). The failure mode was via dielectric breakdown of the hose resulting in arcing, which caused (a) pinhole(s) in the hose.

A modified hose 120 was constructed by adding another layer 52 between the inner layer 22 and the ground sleeve 38. Layer 52 fits loosely over the pressure hose to minimize pressure effects and to permit any moisture that diffuses through layer 22 to vent. Since the insulation layer 52 is not directly exposed to the coating material or its pressure, any suitably electrically non-conductive material such as, for example, nylons, various elastomers, PVC, and so on can be used. Additionally, with solvent based systems, it is possible that chemical resistance may be a factor affecting diffusion through the inner layer 22 and spillage of coating material and/or solvent onto layer 52. Even taking this into consideration, however, material compatibility for layer 52 is much less of a factor in selecting the materials for layer 52. Layer 52 can be extruded with grooves or ridges permitting easier assembly of hose 20 into layer 52, and contributing little loss to the flexibility of the inserted layer 22. To have the least effect on flexibility, layer 52 should have low flexural strength and some looseness should be maintained between the inserted hose 20 and the layer 52. The ground sleeve 38 is then placed over layer 52. Ground sleeve 38 can be of the same general type as the semiconducting braid ground sleeve 38 used with hose 20, or ground sleeve 38 can be a conducting metal braid, or ground sleeve 38 can be a conductive or semiconductive layer co-extruded with the layer 52. With the hose 120, the layer 52 is decoupled from the coating material pressure inside layer 22. Even if water were to migrate through the sidewall of layer 22 through the influence of the electric field and pressure, the added insulation of layer 52, by not permitting current to flow, would reduce the likelihood of the pinhole formation seen with the original hose 20. Further, the added thickness of layer 52 reduces the electric field gradient, thus reducing the effects of the electric field on diffusion through the layer 22.

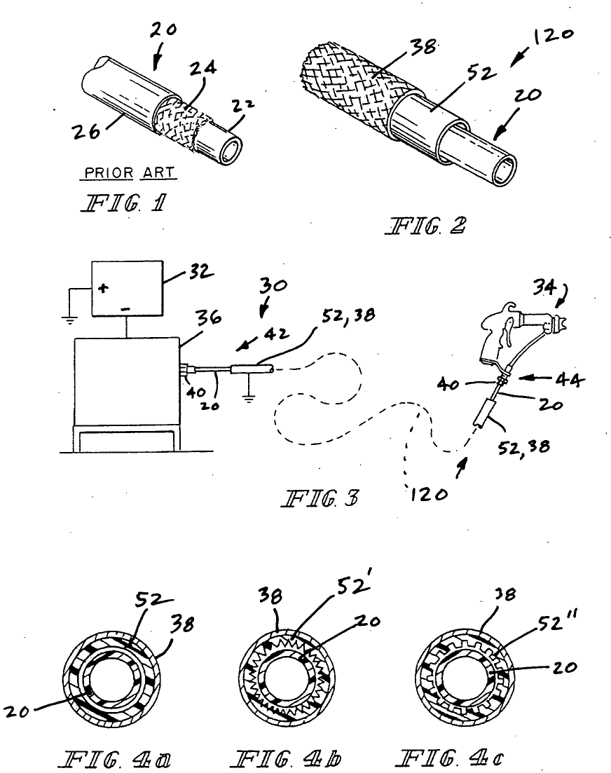

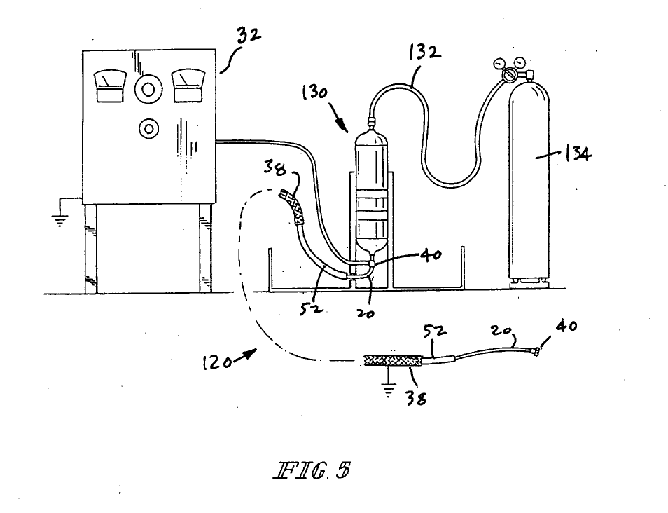

The structure of the hose 120 is further illustrated in FIGS. 2-4. The layers 20, 52, 38 of the hose 120 are illustrated in FIG. 2. The two outer layers 52, 38 are the new unpressurized insulation layer 52 and the ground layer 38. These two layers 52, 38 can be combined into one structure by co-extrusion or they can be two distinct layers. The overall structure of the hose 120 is illustrated in FIGS. 3-5. FIG. 3 illustrates the embodiment in which the hose 120 includes the insulation layer 52 and the ground layer 38 ending together as would be the case if they were co-extruded. Referring to FIG. 5, the hose 120 may also be configured with the insulating layer 52 extending beyond the ground layer 38, as might be the case if the insulating layer 52 were slipped over the hose 20 and the ground layer 38 were then slipped over the resulting subassembly. FIGS. 4a-c illustrate cross-sections of various embodiments of insulating layer 52 and ground layer 38. Three profiles are illustrated. In FIG. 4a, a standard circular profile is illustrated. In FIGS. 4b and 4c, two different grooved profiles are illustrated. Such grooved profiles can be used to aid in spacing the layer 52, 52′, 52″ from the inner high-pressure hose 20 and, in addition, ease assembly by reducing contact between layer 52, 52′, 52″ and hose 20.

A test hose 120 incorporated a high-pressure hose 20 having an inner layer 22 of PTFE with an inner diameter of about 6.9 mm and an outer diameter of about 10.32 mm. The layer 26 was polyurethane with thickness of about 1.25 mm and an outer diameter of about 14 mm. A braided covering 24 of either aramid or polyester fibers was placed between the PTFE inner layer 22 and the outer layer 26. The insulating layer 52 was flexible PVC tubing with an inner diameter of about 0.75 inch (about 1.9 cm) and an outer diameter of 1.5 inches (about 3.8 cm). The ground layer 38 was unlined flexible metal hose, illustratively, woven 304 stainless steel with an inside diameter of about 1.625 inches (about 41.3 mm), a wall thickness of about 0.1 inch (about 2.54 mm), and a bend radius of about 13 inches (about 33 cm). The test configuration is illustrated in FIG. 5.

The test hose 120 was first filled with water and attached to a small pressure vessel 130, such as a Hoke vessel. Vessel 130 was filled with water and then attached via a non-conductive hose 132 to a nitrogen cylinder 134. The assembly was then pressurized to about 1,500 lb./in.² (about 103 bar or about 78,280 mm Hg or about 10,436 kPa) and checked for leakage. After leak checking over the span of about a day with no voltage, the test hose 120 and the ground were coupled to the high voltage and ground connections, respectively, of a power supply 32, illustratively, a Ransburg model 253-17254 power supply. The power supply 32 output voltage was set at 50 kV. The test hose 120 was then held at about 1,500 lb./in.² (about 103 bar or about 78,280 mm Hg or about 10,436 kPa) and 50 kV for a period of 235 hours before the test was terminated without failure. For the second portion of the test, test hose 120 was pressurized to about 2,800 lb./in.² (about 193 bar or about 146,680 mm Hg or about 19,556 kPa) and 50 kV was applied across the power supply 32 terminals. Test hose 120 was then held with these parameters for 510 hours before the test was terminated without failure. These results are in marked contrast to previous tests with the prior art hose 20, with ground layer 38 but no insulating layer 52.

Although the hose 20 illustrated in FIG. 1 was adequate for the pressures used in certain coating dispensing systems, and for the voltages applied from the interior to the ground when separately tested for these, the combined effects of pressure and voltage resulted in leakage of the solvent, in this case, water, through the hose 20 wall, leading to shorting of the voltage and failure of the hose 20. By addition of an outer hose 52 and ground layer 38, the electrical isolation provided by outer hose 52 and no exposure of outer hose 52 to pressure within hose 20, a viable composite hose 120 is provided for the target conditions without increasing the thickness of the inner hose 20 to the point where its flexibility is compromised. Use of a loose fitting outer hose 52 permits the inner high-pressure hose 20 to move independently within the outer hose 52 and ground layer 38, maintaining flexibility while reducing hose 20 failure.

What is claimed is:

1. In combination, a first conduit providing a first passageway for material to be conveyed through the conduit, an electrically non-conductive second conduit including a second passageway adapted loosely to receive the first conduit, and an electrically non-insulative layer surrounding the second conduit.

2. The combination of claim 1 wherein the electrically non-insulative layer comprises flexible metal hose around the second conduit.

3. The combination of claim 1 wherein the electrically non-insulative layer comprises a semiconducting braid around the second conduit.

4. The combination of claim 1 wherein the electrically non-insulative layer comprises a non-insulative layer co-extruded with the second conduit

5. The combination of claim 1 wherein the electrically non-insulative layer comprises a semiconductive layer co-extruded with the second conduit

6. The combination of claim 1 wherein the source of coating material comprises a source of electrically non-insulative coating material.

7. The combination of claim 1 wherein the second passageway comprises lands and grooves extending longitudinally of the second conduit to aid in insertion of the first conduit into the second conduit.

8. The combination of claim 1 wherein the first conduit comprises an electrically non-conductive material.

9. The combination of claim 1 further including a coating dispensing device, a source of coating material to be dispensed by the coating dispensing device and a power supply including output terminals across which a potential is maintained, the first conduit being coupled between the source and the coating dispensing device, one of the output terminals coupled to at least one of the coating dispensing device, the source of coating material and the coating material being supplied through the first passageway, and the other of the output terminals coupled to the electrically non-insulative layer surrounding the second conduit.

10. The combination of claim 9 wherein the first conduit is adapted to withstand pressure exerted on it by coating material supplied from the source of coating material.

11. The combination of claim 10 wherein the first conduit comprises an electrically non-conductive material.

12. The combination of claim 9 wherein the second passageway comprises lands and grooves extending longitudinally of the second conduit to aid in insertion of the first conduit into the second conduit.

13. The combination of claim 9 wherein the first conduit comprises an electrically non-conductive material.

14. The combination of claim 9 wherein the electrically non-insulative layer comprises flexible metal hose around the second conduit.

15. The combination of claim 9 wherein the electrically non-insulative layer comprises a semiconducting braid around the second conduit.

16. The combination of claim 9 wherein the electrically non-insulative layer comprises a non-insulative layer co-extruded with the second conduit

17. The combination of claim 9 wherein the electrically non-insulative layer comprises a semiconductive layer co-extruded with the second conduit

18. The combination of claim 9 wherein the source of coating material comprises a source of electrically non-insulative coating material.

19. The combination of claim 9 wherein the second passageway comprises lands and grooves extending longitudinally of the second conduit to aid in insertion of the first conduit into the second conduit.

20. The combination of claim 9 wherein the first conduit comprises an electrically non-conductive material.
